(19) United States
(12) Patent Application Publication
(10) Pub. No.: US 2026/0091593 A1
(43) Pub. Date: Apr. 2, 2026

(54) LIQUID EJECTION APPARATUS, LIQUID EJECTION HEAD, LIQUID EJECTION HEAD CONTROL DEVICE, AND LIQUID EJECTION HEAD CONTROLLING METHOD

(71) Applicant: CANON KABUSHIKI KAISHA, Tokyo (JP)

(72) Inventor: KAZUKI HIROBE, Tokyo (JP)

(21) Appl. No.: 19/347,381

(22) Filed: Oct. 1, 2025

(30) Foreign Application Priority Data
Oct. 2, 2024 (JP) 2024-173863

(51) Int. Cl. B41J 2/20; B41J 2/045; B41J 2/18

(52) U.S. Cl. CPC B41J 2/20; B41J 2/04533; B41J 2/04541; B41J 2/04573; B41J 2/0458; B41J 2/04588; B41J 2/04596; B41J 2/18

(57) ABSTRACT

A liquid ejection apparatus includes a liquid ejection head and a control unit that controls this head. The liquid ejection head includes ejection energy generating elements for ejecting the liquid present in pressure chambers from ejection ports, circulation energy generating elements for circulating the liquid present in the pressure chambers inside the liquid ejection head, and a unit that inputs ejection energy generating element selection signals, ejection time-division selection signals, and a circulation cycle control signal. The liquid ejection head circulates the liquid by driving the circulation energy generating element selected by the circulation energy generation element selection signal and the circulation time-division selection signal. The control unit includes a unit that generates the circulation cycle control signal such that a cycle of the circulation timedivision selection signals is equal to or longer than a cycle of the ejection time-division selection signals.

### BACKGROUND

### Field of the Technology

The present disclosure relates to a liquid ejection head for ejecting a liquid to a print medium, a liquid ejection apparatus including the liquid ejection head, a liquid ejection head control device for controlling the liquid ejection head, and a liquid ejection head controlling method.

### DESCRIPTION OF THE RELATED ART

There has been known an inkjet printing apparatus (also simply referred to as a "printing apparatus") of a circulating type, which circulates an ink for the purposes of discharge of bubbles in a flow channel and inhibition of an increase in viscosity of the ink in the vicinity of ejection ports in a liquid ejection head (hereinafter also referred to as a "head"). A method of employing a pressure difference (hereinafter also referred to as a "differential pressure method") has been well known as a method (a system) of circulating the ink. In the differential pressure method, a pressure adjustment mechanism or the like is used in order to perform control in such a way as to bring a pressure on a side to supply the ink (an inward side) to an ejection port higher than a pressure on a side to collect the ink (an outward side), thereby causing the ink to flow in from the inward side to the outward side. In this instance, the ink that flowed to the outward side needs to be returned to the inward side in order to circulate the ink, and a circulating pump (also simply referred to as a "pump") is required as a mechanism for this purpose. There is a configuration to provide the pump to outside of the head such as a printing apparatus main body so as to circulate the ink between the liquid ejection head and the main body, and there is also a configuration to provide the pump inside the liquid ejection head so as to circulate the ink inside the liquid ejection head. However, the circulating method adopting the differential pressure as described above requires the mechanisms including the pressure adjustment mechanism, the pump, and the like, and the printing apparatus body and the head tend to be increased in size.

This is why a method of circulating an ink without using a differential pressure is under consideration. To be more precise, a circulation flow channel that communicates with ejection ports is provided. Then, an energy generating element (hereinafter also referred to as an "ejection energy generating element") for ejecting the ink and an energy generating element (hereinafter also referred to as a "circulation energy generating element") for circulating the ink are disposed in the circulation flow channel. The ink is circulated in a circulation path by driving the circulation energy generating clement.

Japanese Patent Laid-Open No. 2020-507497 discloses a circuit configuration for selectively driving multiple ejection energy generating elements and multiple circulation energy generating elements provided to a printing element substrate.

However, according to Japanese Patent Laid-Open No. 2020-507497, addresses are allocated so as to be able to individually select the ejection energy generating elements and the circulation energy generating elements, respectively. In a case of individually designating addresses and transferring data signal from an ink jet printing apparatus side to the energy generating elements having different functions, respectively, there is a problem of an increase in amount of data in accordance with the number of the energy generating elements. A conceivable configuration to reduce the amount of data is to convert selection information on the circulation energy generating elements inside the printing element substrate depending on selection information on the ejection energy generating elements, and to select each of the circulation energy generating elements. In this case, since the ejection energy generating elements and the circulation energy generating elements are selected by the same drive frequency, there is a problem that the circulation energy generating elements cannot be driven by an optimum drive frequency for the circulation energy generating elements. For example, there is a problem that ideal ink circulation is not feasible in a case where the drive frequency of the circulation energy generating elements is equal to the drive frequency of the ejection energy generating elements and this drive frequency is faster than the optimum drive frequency for the circulation energy generating elements.

### SUMMARY

An object of the present disclosure is to make it possible to drive a circulation energy generating element at a frequency different from a frequency applicable to an ejection energy generating element.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically showing a liquid ejection apparatus.

FIG. 1B is a perspective view schematically showing another liquid ejection apparatus.

FIG. 2A is a schematic diagram describing the vicinity of ejection ports of a liquid ejection head in detail.

FIG. 2B is a schematic diagram describing the vicinity of an ejection port of the liquid ejection head in detail.

FIG. 2C is another schematic diagram describing the vicinity of the ejection port of the liquid ejection head in detail.

FIG. 3A is a perspective view showing the liquid ejection head.

FIG. 3B is a plan view of a liquid ejection chip.

FIG. 3C is a plan view of another liquid ejection chip.

FIG. 3D is a plan view of still another liquid ejection chip.

FIG. 4 is a functional block diagram showing a configuration example of the liquid ejection head.

FIG. 5 is a functional block diagram showing a configuration of the liquid ejection apparatus.

FIG. 6 is a timing chart for explaining an operation of a timing generating unit.

FIG. 7 is a functional block diagram showing a configuration of a liquid ejection head control unit.

FIG. 8 is a timing chart showing signals to be generated by the liquid ejection head control unit.

FIG. 9A is a timing chart showing an example of generation of a circulation cycle control signal.

FIG. 9B is a timing chart showing another example of generation of the circulation cycle control signal.

FIG. 10 is a functional block diagram showing a configuration example of a circulation cycle control signal generating unit.

FIG. 11 is a timing chart showing signals to be generated by the circulation cycle control signal generating unit.

FIG. 12 is a flowchart showing an operation example of the circulation cycle control signal generating unit.

FIG. 13 is a functional block diagram showing another configuration example of the liquid ejection head.

FIG. 14A is a circuit diagram showing a configuration example of a circulation group selection signal generating unit.

FIG. 14B is a circuit diagram showing a configuration example of a circulation time-division selection signal generating unit.

FIG. 15 is a functional block diagram showing still another configuration example of the liquid ejection head.

FIG. 16 is a circuit diagram showing a configuration example of a circulation adjusting unit.

### DESCRIPTION OF THE EMBODIMENTS

A preferred embodiment of the present disclosure will be described below in detail with reference to the accompanying drawings. Note that the following embodiment is not intended to limit the matters pertaining to the present disclosure. Moreover, the entire combination of all of the features described in the present embodiment is not always essential for a solution of the present disclosure. Here, the same constituents are denoted by the same reference signs. In the following description, a basic configuration of the present disclosure will be discussed to begin with, and characteristic features of the present disclosure will be explained thereafter.

### Constituents of circulation unit

### Liquid ejection apparatus

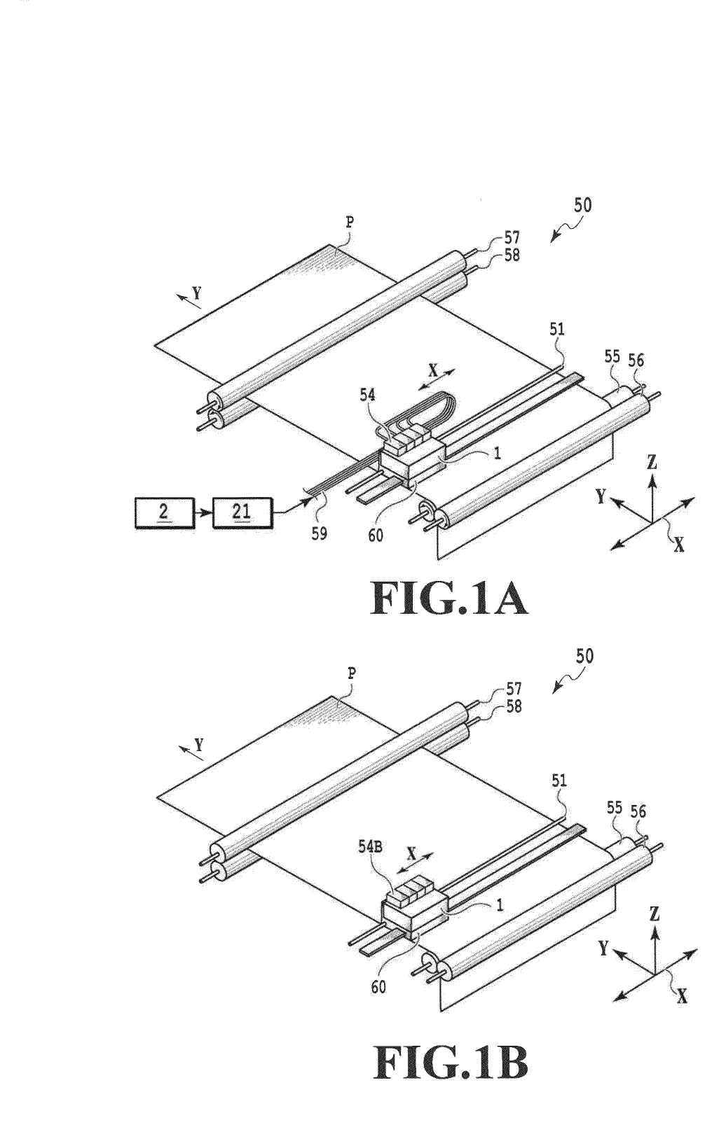

A schematic configuration of a liquid ejection apparatus 50 of the present embodiment will be described to begin with. FIGS. 1A and 1B are perspective views schematically showing two types of the liquid ejection apparatuses.

The liquid ejection apparatus 50 described in FIGS. 1A and 1B is a liquid ejection apparatus configured to perform image printing by ejecting liquids to a print medium P with a liquid ejection head that performs scanning in a direction intersecting with a conveyance direction of the print medium P (a liquid ejection apparatus of a serial type). The present disclosure is not limited only to the liquid ejection apparatus of the serial type. The present disclosure is also applicable to a page-wide type liquid ejection apparatus which performs image printing by ejecting liquids to a print medium conveyed in the conveyance direction by using a line head (a page-wide type head) that is long in a page width direction of the print medium. Here, the liquid ejection head in the present embodiment can eject four types of inks of black (K), cyan (C), magenta (M), and yellow (Y), and can print full-color images by using these inks. The inks that can be ejected from the liquid ejection head are not limited to the aforementioned four types of inks. The present disclosure is also applicable to a liquid ejection head for ejecting other types of inks. That is to say, the types and the number of inks to be ejected from the liquid ejection head are not limited.

In the liquid ejection apparatus 50 of the serial type, a liquid ejection head 1 is mounted on a carriage 60. The carriage 60 reciprocally moves along a guide shaft 51 that extends in a main scanning direction (x direction). The print medium is conveyed in a sub scanning direction (y direction) which intersects (at right angle in the case of the present example) with the main scanning direction by using conveyance rollers (conveyance units) 55, 56, 57, and 58. Here, in the respective drawings to be hereinafter referred to, z direction represents a vertical direction which intersects (at right angle in the case of the present example) with x-y plane defined by the x direction and the y direction.

FIG. 1A shows a configuration to provide a main ink tank 2 as a liquid reservoir unit on the outside of the liquid ejection head. Liquids (inks) reserved in the ink tank 2 are supplied to a sub ink tank 54 located on the liquid ejection head 1 side through ink supply tubes (liquid communication channels) 59 and the like by using drive force of an external pump 21. On the other hand, FIG. 1B shows a configuration to provide an ink tank 54B located immediately above the liquid ejection head 1 without providing the main ink tank 2 as the liquid reservoir unit on the outside of the liquid ejection head. In the configuration of FIG. 1B, there may be a case where the liquid ejection head 1 is provided integrally with the ink tank 54B and configured to be attachable to and detachable from the carriage 60. Meanwhile, there may also be a case where the liquid ejection head 1 is provided integrally with the carriage 60, and only the ink tank 54B is configured to be attachable and detachable. The following description will be given by using the configuration of FIG. 1A as a representative example.

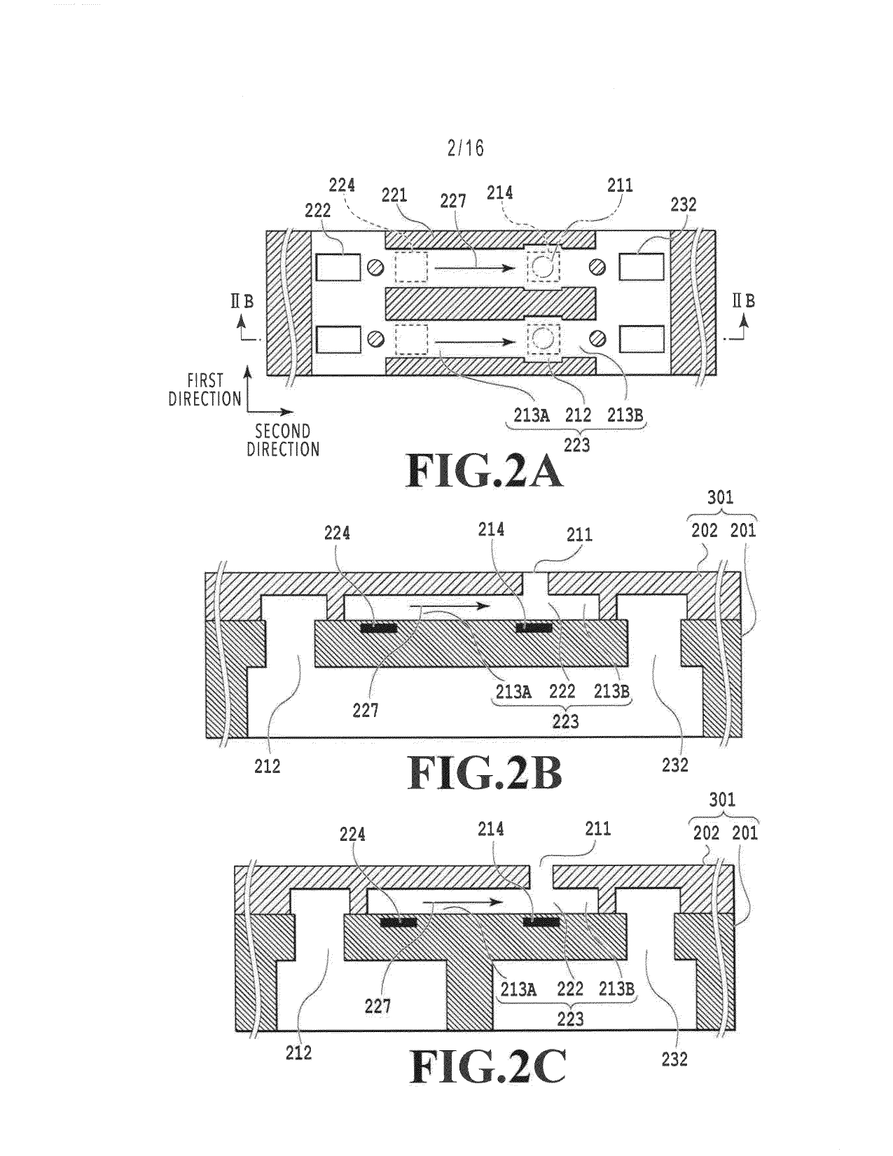

The liquid ejection head 1 includes individual ejection units to be described later. Although specific configurations will be described later, as shown in FIGS. 2A to 2C, each individual ejection unit is provided with an ejection port 211 for ejecting the liquid and a pressure chamber 212 communicating with the ejection port 211. Moreover, the individual ejection unit includes a first energy generating element (an ejection energy generating element) 214 provided to the pressure chamber 212 and configured to generate energy for ejecting the liquid from the ejection port 211. In addition, the individual ejection unit includes an individual flow channel 223 communicating with the pressure chamber 212, and a second energy generating element (a circulation energy generating element) 224 provided to the individual flow channel 223. The liquid ejection head 1 includes multiple individual ejection units, and has supply flow channels for supplying the liquids to the individual flow channels of the respective individual ejection units.

In the course of using the liquid ejection head, ejection of the liquids may be unstable due to evaporation of volatile components such as moisture from the ejection ports, condensation of solid contents in the vicinity of the ejection ports in association therewith, and the like. Various devices have been adopted in order to prevent such problems. For example, it is possible to provide the liquid ejection apparatus with a cap member (not shown), which is located at a position deviated in the x direction from a conveyance path for the print medium and is capable of covering an ejection port surface where the ejection ports of the liquid ejection head are formed. The cap member is used for the purpose of covering the ejection port surface of the liquid ejection head in a case of not carrying out a printing operation and the like, so as to prevent drying and to achieve protection of the ejection ports. Moreover, it is also possible to provide an ink suction mechanism (not shown). In that case, the cap member is used for an ink suctioning operation from the ejection ports, and the like. By carrying out this ink suctioning operation, it is possible to refresh the inks in the vicinity of the ejection ports and to maintain quality of obtained images. Meanwhile, there has also been known a method of discarding condensed inks by carrying out ejection called preliminary ejection (preliminary discharge) in the case where the printing operation does not take place. Furthermore, there has also been known a method of preliminarily ejecting a nominal amount of an ink (preliminary ejection on a sheet surface / preliminary ejection in a page) at an unnoticeable location in terms of image quality on the print medium during the printing operation. Although these methods significantly contribute to improvement in image quality, the inks are partially discarded in order to refresh the ejection ports. Accordingly, amounts of the discarded inks need to be reduced as much as possible while refreshing the ejection ports.

Regarding the above-mentioned problem, it is possible to suppress drying at the ejection ports and condensation of the inks in the vicinity of the ejection ports while reducing the amounts of the discarded inks by providing the second energy generating elements (the circulation energy generating elements) 224 in the individual flow channels so as to circulate the inks inside the individual flow channels. To be more precise, it is possible to minimize the numbers of times of preliminary ejection and suction recovery. Moreover, minimizing the numbers of times of preliminary ejection and so forth also lead to improvements in throughput and yield.

The circulation energy generating elements 224 do not always have to be provided to all of the individual ejection units in the liquid ejection head. The above mentioned effect is available as compared to the case of not providing the circulation energy generating elements 224 as long as the circulation energy generating elements 224 are provided to some of the individual ejection units.

Meanwhile, the liquid ejection head shown in FIG. 1A may have a configuration to provide all of the locations corresponding to the four types of the inks with the circulation energy generating elements 224 or a configuration to provide only the location corresponding to one type of the ink with the circulation energy generating elements 224. That is to say, the liquid ejection head may be configured to circulate at least one type of the ink instead of circulating all of the four types of the inks.

### Basic configuration of liquid ejection head

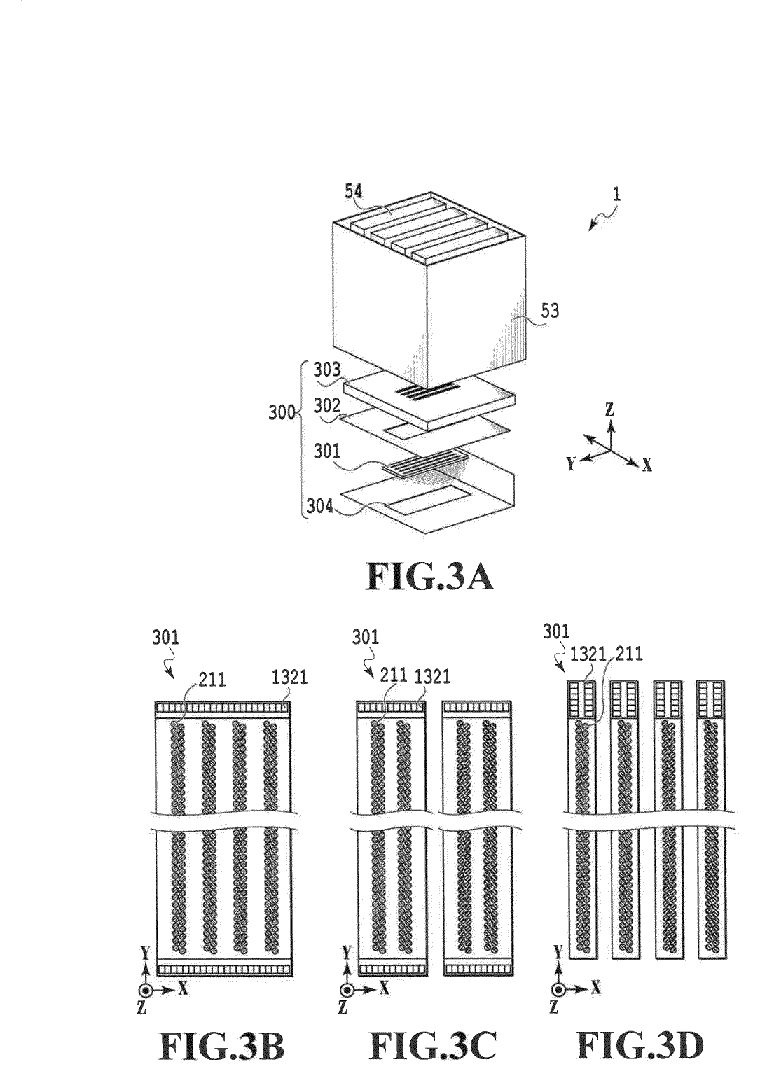

FIG. 3A is an exploded perspective view of the liquid ejection head of the present embodiment. As shown in FIGS. 3A to 3C, the liquid ejection head 1 includes the sub ink tank 54 that temporarily reserves the inks in the head, and a liquid ejection chip 301 for ejecting the inks supplied from the sub ink tank 54 to the print medium P. The liquid ejection head 1 in the present embodiment is fixed to and supported by the carriage 60 by using a positioning unit and electrical contacts which are not illustrated and are provided to the carriage 60 of the liquid ejection apparatus 50. The liquid ejection head 1 ejects the inks while moving in the main scanning direction (the x direction) shown in FIGS. 1A and 1B together with the carriage 60, and thus performs printing on the print medium P.

Here, the liquid ejection head 1 includes an ejection unit 300 as shown in FIG. 3A. Moreover, the ejection unit 300 includes a first support member 4, a second support member 7, the liquid ejection chip 301, and an electric wiring member (an electric wiring tape) 204.

The external pump 21 connected to the ink tank 2 and serving as a supply source of the inks is provided with ink supply tubes 59 (see FIG. 1A). Not illustrated liquid connectors are provided at tip ends of these ink supply tubes 59. In the case where the liquid ejection head 1 is mounted on the liquid ejection apparatus 50, the liquid connectors provided at the tip ends of the ink supply tubes 59 are liquid-tightly connected to liquid connector insertion slots being inlets of the liquids provided to a head casing 53 of the liquid ejection head 1. In this way, an ink supply channel extending from the ink tank 2 to the liquid ejection head 1 through the external pump 21 is formed. Since the four types of the inks are used in the present embodiment, four sets of the ink tanks 2, the external pumps 21, the ink supply tubes 59, and the sub ink tanks 54 are provided corresponding to the respective inks, whereby the four ink supply channels corresponding to the respective inks are independently formed. As described above, the liquid ejection apparatus 50 of the present embodiment includes an ink supply system that supplies the inks from the ink tanks 2 provided on the outside of the liquid ejection head 1. Note that the liquid ejection apparatus 50 of the present embodiment is not provided with an ink collection system to collect the inks in the liquid ejection head 1 back to the ink tanks. Accordingly, the liquid ejection head 1 includes the liquid connector insertion slots to establish connection to the ink supply tubes 59 of the ink tanks 2 but does not include connector insertion slots to establish connection to tubes for collecting the inks in the liquid ejection head 1 back to the ink tanks 2. Here, the liquid connector insertion slots are provided for the respective inks.

FIGS. 3B, 3C, and 3D are plan views of liquid ejection chips 301 constituting the liquid ejection head, which are viewed from the ejection surface side. FIG. 3B shows a configuration in which one chip is provided for four colors. FIG. 3C shows a configuration in which one chip is provided for two colors. FIG. 3D shows a configuration in which one chip is provided for one color. Each liquid ejection chip 301 is provided with the ejection ports 211 and pads 1321 used for electrical mounting. FIG. 3A shows the one-chip configuration of FIG. 3B.

FIG. 3B shows the configuration in which one chip is provided for four colors. The four colors include black, cyan, magenta, and yellow, for example, and each color is allocated to a line extending in the y direction. In the example shown in FIG. 3B, the ejection ports of each color are arranged in a staggered manner in two rows extending in the y direction. Here, a pitch of the ejection ports along the y direction is constant. The ejection ports of each color may be arranged in one row along the y direction instead. Moreover, only the ejection ports of black may be arranged in two rows and the ejection ports of any other colors may be arranged in one row. In that case, the total number of rows is equal to 5.

FIG. 3C shows a configuration to set the number of chips equal to 2 by allocating two colors to one chip. In this case, two chips may be mounted on one liquid ejection head, or one chip may be mounted on one liquid ejection head and the number of heads may be set equal to 2.

FIG. 3D shows a configuration to set the number of chips equal to 4 by allocating one color to one chip. In this case, four chips may be mounted on one liquid ejection head, or one chip may be mounted on one liquid ejection head and the number of heads may be set equal to 4. Moreover, two chips may be mounted on one liquid ejection head and the number of heads may be set equal to 2.

Meanwhile, in the case of dividing the chips into two or more pieces as shown in FIGS. 3C and 3D, it is not always necessary to set the lengths of all the chips in common. In the meantime, it is free to choose a combination to allocate the multiple colors to the multiple chips. The same applies to a case where the total number of colors is larger than four (a simple straight type).

FIGS. 2A to 2C are schematic diagrams describing the vicinity of the ejection ports of the liquid ejection head to eject the liquids such as the inks in detail. FIG. 2A is a plan view from a direction of ejection of liquid droplets from the ejection ports. FIG. 2B is a cross-sectional view of a first configuration taken along the 'IIB-IIB line in FIG. 2A. FIG. 2C is a cross-sectional view of a second configuration taken along the 'IIB-IIB line in FIG. 2A.

In FIGS. 2A to 2C, the pressure chambers 212 being partitioned by partition walls 221 and corresponding to the respective ejection ports 211, and the individual flow channels 223 for feeding the inks through those pressure chambers 212 are formed between a printing element substrate 201 and an orifice plate 202. An ink meniscus is provided on each ejection port 211, thus forming an ejection port interface being an interface between the ink and atmosphere.

The printing element substrate 201 is provided with the ejection energy generating elements 214 that generate the energy for ejecting the inks inside the pressure chambers. In the present example, electrothermal transducing elements are used as the ejection energy generating elements 214. As with locations of the ejection ports 211 and the pressure chambers 212, a location of each ejection energy generating element 214 is closer to a second opening (an outflow opening) 232 than to a first opening (a supply opening) 222. By driving the ejection energy generating element 214 to generate heat and thus generating a bubble of the ink inside the pressure chamber 212, the ink can be ejected from the ejection port 211 by using the bubble generation energy. The ejection energy generating element 214 is not limited to the electrothermal transducing element of the present example, and a piezoelectric element and the like can be used instead. Meanwhile, the printing element substrate 201 is provided with the circulation energy generating elements 224 that generate energy for creating circulation flows 227 of the inks inside the individual flow channels as indicated with arrows. In the present example, electrothermal transducing elements are used as the circulation energy generating elements 224. A location of each circulation energy generating element 224 is closer to the first opening 222 than to the second opening 232.

The individual flow channels 223 extend in a second direction which intersects (at right angle in the case of the present example) with a row of ejection ports arranged in a first direction. Each individual flow channel 223 includes the pressure chamber 212, a connection flow channel 213A on an inlet (upstream) side in FIG. 2B which communicates with one end portion of the pressure chamber 212, and a connection flow channel 213B on an outlet (downstream) side in FIG. 2B which communicates with another end portion of the pressure chamber 212. The individual flow channel 223 communicates with the first opening 222 and the second opening 232, which penetrate the printing element substrate 201 on two sides. Accordingly, the connection flow channel 213A is located on the left side relative to the row of ejection ports in FIGS. 2A, 2B, and 2C. The connection flow channel 213B is located on the right side relative to the row of ejection ports. Two end portions of the individual flow channel 223 are located on opposite sides from each other while interposing the row of ejection ports in between.

Ink flows flowing on the individual flow channel 223 are broadly categorized into the following two flows:

(1) an ink flow caused by driving the first energy generating element 214 for refilling after ejection; and

(2) an ink flow caused by driving the second energy generating element 224 for creating the circulation flow.

In the case of ejecting the liquid from the ejection port 211 by driving the first energy generating element 214, the ink flows in from the first opening 222 and the second opening 232 in order to supply the ink in association with ejection.

In the case of creating the circulation flow by driving the second energy generating element 224, the individual flow channel 223 flows the ink in through the first opening 222 on the connection flow channel side, and flows the ink to outside through the second opening 232 not on the connection flow channel side. In the present example, the ink flowing out of the second opening 232 is returned to the first opening 222 to bring about circulation, thereby creating the circulation flow 227 indicated with the arrow inside the individual flow channel 223.

Note that FIG. 2B shows the configuration in which the first opening 222 and the second opening 232 are connected to the individual flow channel 223 and are communalized outside the liquid ejection head. On the other hand, FIG. 2C shows the configuration in which the first opening 222 and the second opening 232 are not communalized inside the chip. Any of these configurations may be adopted.

A filter for removing foreign substances in the ink may be provided in an ink circulation flow channel inside and outside the liquid ejection head 1. For example, such filters may be disposed on an inflow side being the outside of the individual flow channel 223 and on an outflow side. Alternatively, a filter may be disposed between the ejection energy generating element 214 and the circulation energy generating element 224 in the individual flow channel 223. In this case, a filter need not be disposed on an upstream side (the circulation energy generating element 224 side) being the outside of the individual flow channel 223.

### Driving method of present embodiment: toggle driving

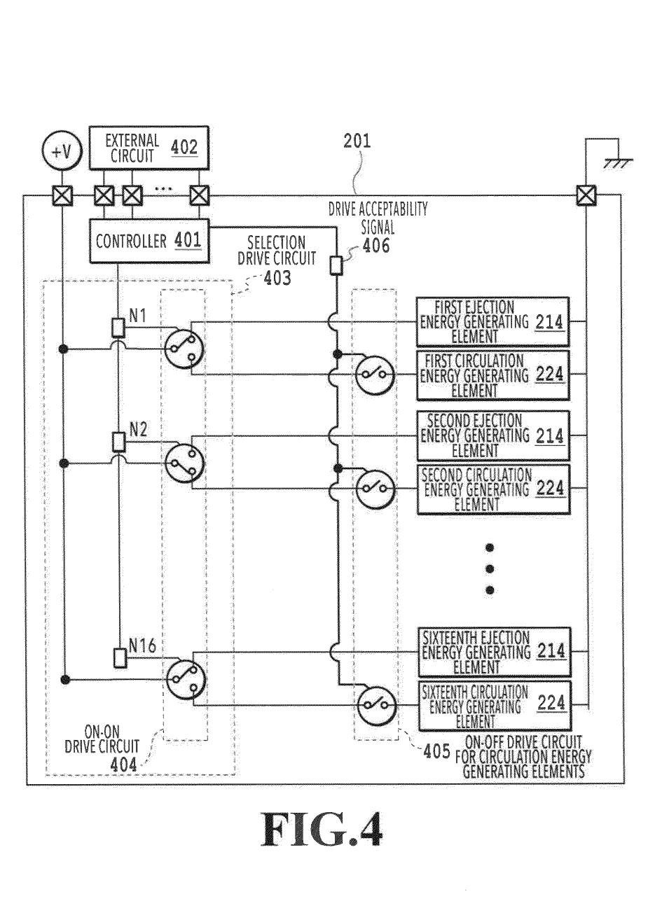

In the present embodiment, a selection drive circuit 403 as shown in FIG. 4A is formed on the printing element substrate 201. A voltage source (+V) and an external circuit 402 provided outside the printing element substrate 201 are connected to the selection drive circuit 403 on the printing element substrate 201. The selection drive circuit 403 includes an on-on drive circuit 404 that turns on and drives any of the ejection energy generating element 214 and the circulation energy generating element 224 in response to control signals at respective addresses (N1 to N16, for instance) received from a controller 401. Here, the controller 401 controls drive pulses for driving the ejection energy generating element 214 or the circulation energy generating element 224, and a time interval of application of the drive pulses to the respective elements. Meanwhile, in the case where the circulation energy generating element 224 is selected by the on-on drive circuit 404, an on-off drive circuit 405 controls drive of the circulation energy generating element 224 in response to a drive acceptability signal 406. As described above, in the present embodiment, the drive of the circulation energy generating element 224 is controlled by the on-on drive circuit 404 and the on-off drive circuit 405.

Accordingly, in the case where the ejection energy generating element 214 is selected by the on-on drive circuit 404, the ejection energy generating element 214 is driven while the circulation energy generating element 224 is not driven regardless of the drive acceptability signal 406.

In the case where the second energy generating element 224 is selected by the on-on drive circuit 404, the ejection energy generating element 214 is not driven regardless of the drive acceptability signal 406.

The circulation energy generating element 224 is driven in a case where the second energy generating element 224 is selected by the on-on drive circuit 404 and the on-off drive circuit 405 is turned on by the drive acceptability signal 406.

The circulation energy generating element 224 is not driven in a case where the second energy generating element 224 is selected by the on-on drive circuit 404 and the on-off drive circuit 405 is turned off by the drive acceptability signal 406. Accordingly, neither the ejection energy generating element 214 nor the circulation energy generating element 224 is driven in the case where the second energy generating element 224 is selected by the on-on drive circuit 404 and the on-off drive circuit 405 is turned off by the drive acceptability signal 406.

Therefore, the circulation energy generating element 224 is subjected to drive control depending on drive data of the ejection energy generating element 214 (control signals at the respective addresses received from the controller 401) and the drive acceptability signal 406. As described above, in the configuration shown in FIG. 4, it is not necessary to provide dedicated drive data regarding the circulation energy generating element 224. Accordingly, this configuration has an advantage that the amount of drive data can be reduced to about a half as compared a case where the dedicated drive data regarding the circulation energy generating element 224 is required.

Meanwhile, it is also possible to subject the multiple circulation energy generating elements 224 to drive control in a lump based on a common drive acceptability signal 406. For example, it is also possible to subject circulation energy generating elements B1 to Bn to drive control based on the drive acceptability signal 406 common to these elements. Note that the value n is set equal to 16 in the example shown in FIG. 4. That is to say, 32 elements (16 sets of elements) of ejection energy generating elements A1 to A16 and the circulation energy generating elements B1 to B16 form one group. Then, the circulation energy generating elements B1 to B16 are subjected to on-off control by using the drive acceptability signal 406 common to these elements. Nonetheless, the value n may be changed to a different value. In the case where the value n is set equal to 8, then the number of elements included in the group is equal to 16. In the case where the value n is set equal to 12, then the number of elements included in the group is equal to 24.

While it is possible to use the electrothermal transducing elements or piezoelectric elements as the circulation energy generating elements 224, the present embodiment employs the electrothermal transducing elements. A direction of each circulation flow is as indicated with the arrow 227. In the case of employing the piezoelectric elements, the direction of the circulation flow may be an opposite direction of the direction of the arrow 227 depending on a driving method thereof.

The present embodiment shows a configuration to introduce the drive acceptability signal 406 to the printing element substrate 201 so as to control the drive of the circulation energy generating elements 224. Moreover, the controller 401, the selection drive circuit 403, and the on-off drive circuit 405 shown in FIG. 4 are formed on he printing element substrate 201. However, the present disclosure is not limited to this configuration, and part or all of the portions for controlling the drive of the circulation energy generating elements 224 may be provided either at a portion in the liquid ejection head 1 except the printing element substrate 201 or at a portion of the liquid ejection apparatus 50 except the liquid ejection head 1. For example, at least part of the controller 401, the selection drive circuit 403, and the on-off drive circuit 405 may be provided at the portion in the liquid ejection head 1 except the printing element substrate 201 or at the portion of the liquid ejection apparatus 50 except the liquid ejection head 1.

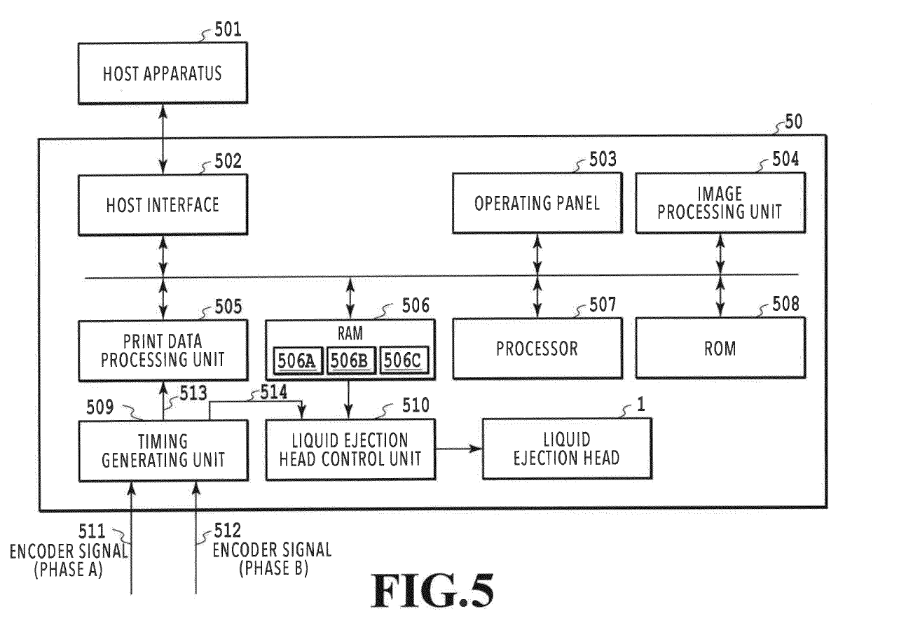

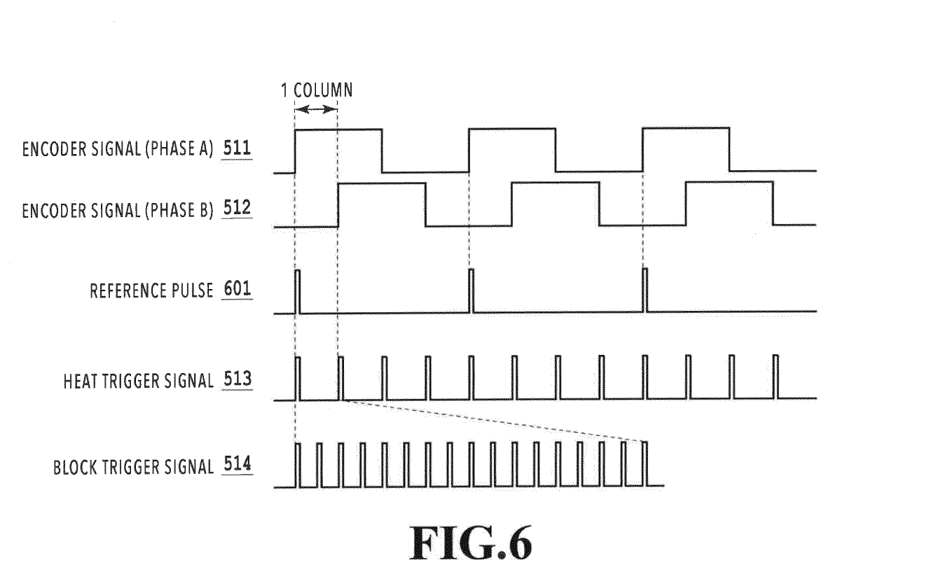

FIG. 5 is a block diagram showing a control configuration of the liquid ejection apparatus 50. A host interface 502 inputs image data from a host apparatus 501. This image data is stored in a reception buffer 506A provided to a RAM 506. An image processing unit 504 converts the image data into multivalued data of color components of CMYK, and stores the converted data into a multivalued data buffer 506B provided to the RAM 506. A print data processing unit 505 converts the multivalued data into dot data (binary data), and stores the converted data into a dot data buffer 506C. A liquid ejection head control unit 510 transfers the binary data stored in the dot data buffer 506C to the liquid ejection head 1. Processing by the print data processing unit 505 is synchronized with a heat trigger signal 513 (see FIG. 6) outputted from a timing generating unit 509. Meanwhile, processing by the liquid ejection head control unit 510 is synchronized with a block trigger signal 514 outputted from the timing generating unit 509. Here, as will be described later, both the heat trigger signal 513 and the block trigger signal 514 are synchronized with encoder signals 511 and 512 each having positional information along a scanning direction (the main scanning direction) of the liquid ejection head 1. Accordingly, each of the processing by the print data processing unit 505 and the processing by the liquid ejection head control unit 510 becomes the processing that matches the scanning timing of the liquid ejection head 1.

Note that reference sign 503 in FIG. 5 denotes an operating panel for allowing a user to issue instructions to the liquid ejection apparatus 50. A processor 507 carries out drive control of printing elements, relative conveyance control between the printing elements and the print medium (such as a paper sheet), and the like in accordance with programs stored in a ROM 508.

Generation of data transfer timing will be described with reference to FIG. 6. Here, a description will be given by using a method of driving print data corresponding to one column into 16 timing sections (time-division drive). The encoder signal (phase A) 511 and the encoder signal (phase B) 512 having a phase that is delayed by one-fourth cycle therefrom are inputted from an encoder, which generates the encoder signals each having the positional information along the scanning direction of the liquid ejection head 1, to the timing generating unit 509. The timing generating unit 509 generates a reference pulse 601 at the timing of a rising edge of the encoder signal 511, and multiplies the reference pulse 601, thereby generating and outputting the heat trigger signal 513 having an interval equivalent to a printing resolution. Moreover, the timing generating unit 509 generates the block trigger signal 514 by dividing the interval of the heat trigger signal 513 by 16. The data is supplied to the liquid ejection head 1 at the timing of this block trigger signal 514. It is possible to print an image and the like at a desired position along the main scanning direction by transferring the data within a period of the cycle of the block trigger signal 514 generated based on the encoder signals 511 and 512 each having the positional information on the liquid ejection head 1 as described above.

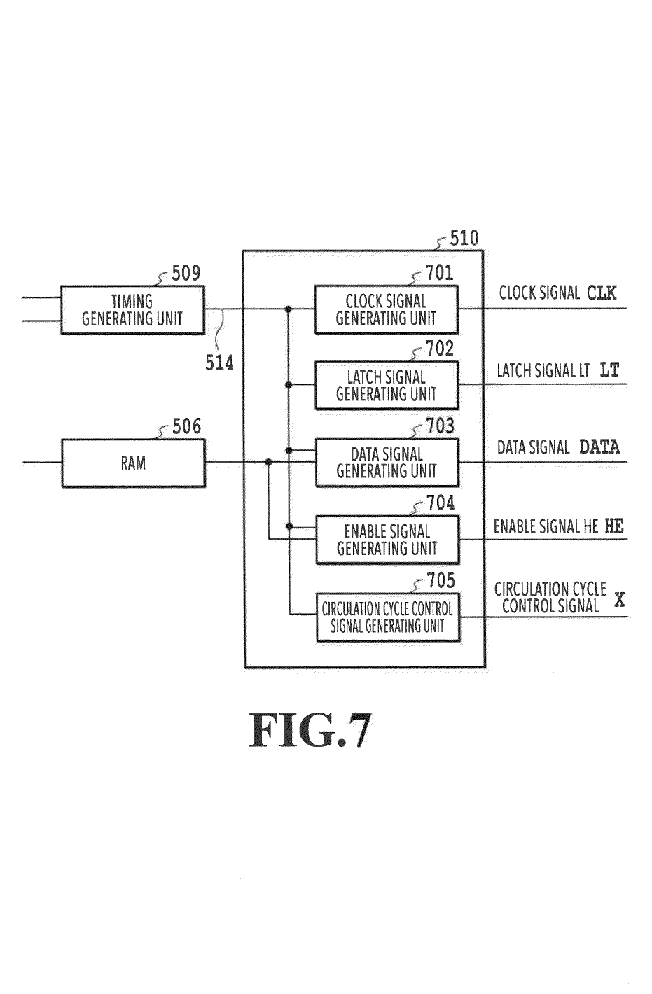

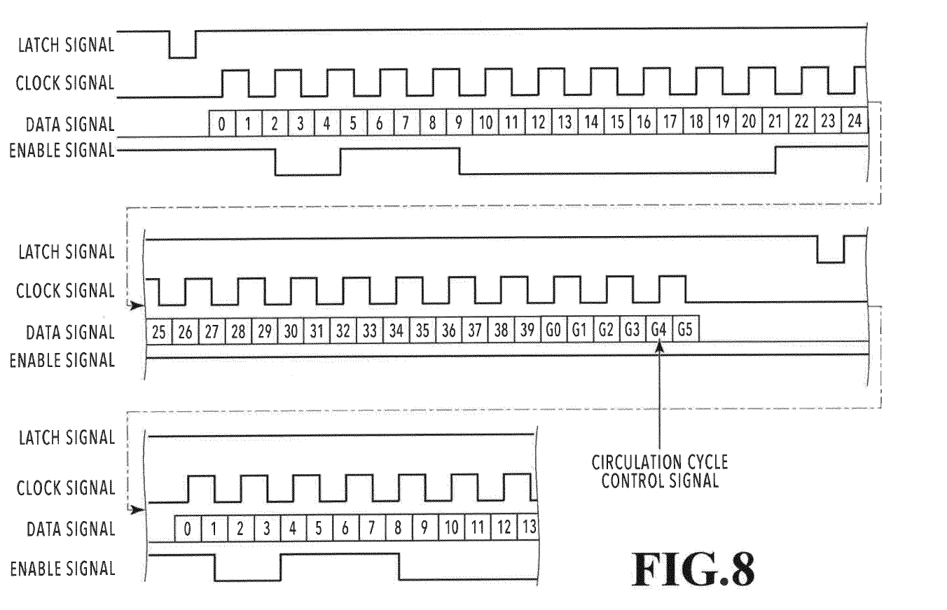

The liquid ejection head control unit 510 will be described with reference to FIGS. 7 and 8.

FIG. 7 is a block diagram showing a configuration of the liquid ejection head control unit 510. The liquid ejection head control unit 510 is operated based on the timing of the block trigger signal 514 generated by the timing generating unit 509.

In a case where the block trigger signal 514 is inputted from the timing generating unit 509, a clock signal generating unit 701 generates a clock signal for a predetermined number of cycles, and transfers the clock signal to the liquid ejection head 1. In the example of FIG. 8, the clock signal generating unit 701 generates the clock signal for 23 cycles for each cycle of a latch signal. The number of cycles of the generated clock signal can be changed by setting, and the required number of cycles is determined by the number of bits of the data to be transferred to the liquid ejection head 1. The clock signal is used, for example, for transmitting serial data in the form of data signals from the liquid ejection head control unit 510 to the printing element substrate 201.

In a case where the block trigger signal 514 is inputted to a latch signal generating unit 702, the latch signal generating unit 702 generates the latch signal and transfers the latch signal to the printing element substrate 201 included in the liquid ejection head 1. The latch signal is used for parallelizing and latching the serial data transmitted from the liquid ejection head control unit 510 to the printing element substrate 201 on the printing element substrate 201, for example.

An enable signal generating unit 704 generates an enable signal based on the data read out of the RAM 506 by a data signal generating unit 703, and transfers the enable signal to the liquid ejection head 1. The enable signal is used for designating a time length for driving the selected energy generating element in one cycle of the latch signal.

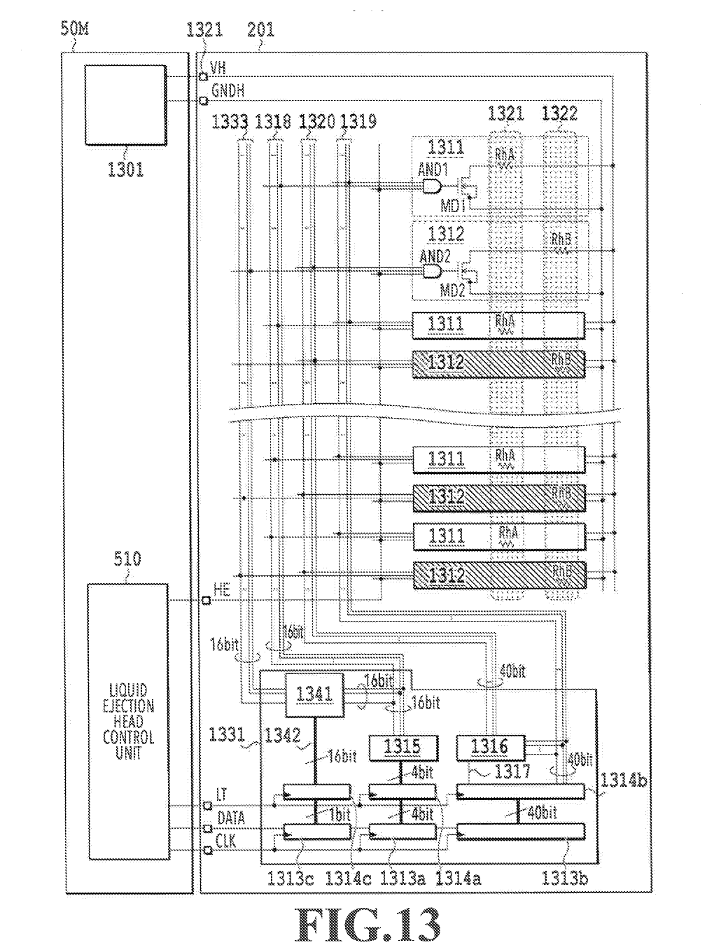

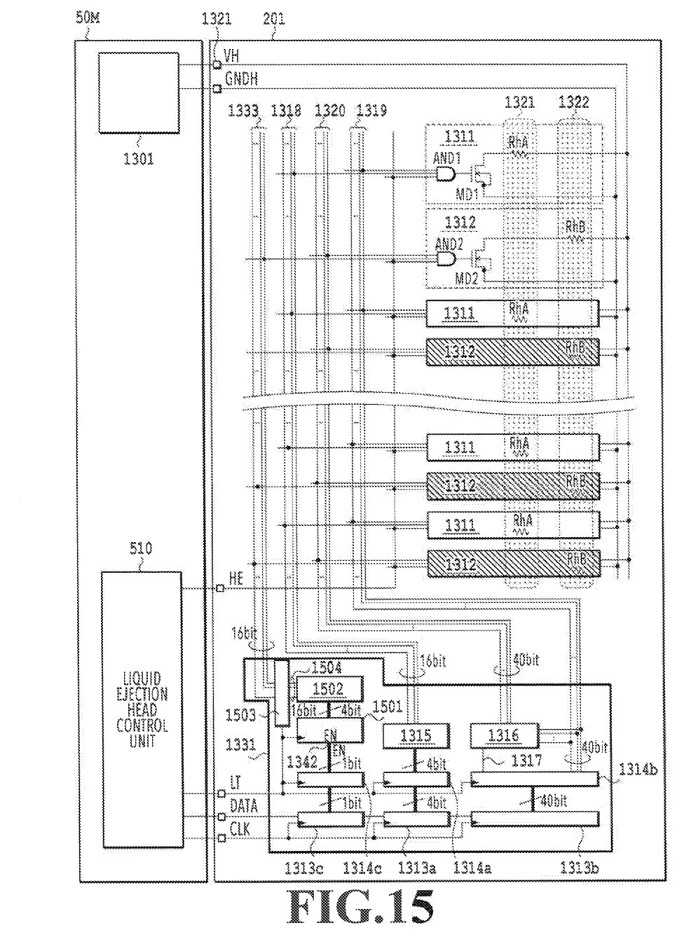

A circulation cycle control signal generating unit 705 (also referred to as a "first generating unit" or more simply as a "generating unit") generates a circulation cycle control signal. The circulation cycle control signal is used for controlling a cycle in which a circulation drive element MD2 (see FIGS. 13 and 15) drives the circulation energy generating element 224. Details will be described later.

The data signal generating unit 703 generates data signals including ejection group selection signals (also referred to as "ejection energy generating element selection signals") and ejection time-division selection signals. In the case where the block trigger signal 514 is inputted, the data signal generating unit 703 reads the data such as the image data out of the RAM 506. Then, the data signal generating unit 703 temporarily stores the ejection group selection signal and the ejection time-division selection signal corresponding to one session of time-division drive based on the read data into an internal buffer. The data signal generating unit 703 transfers the data signal to the printing element substrate 201 included in the liquid ejection chip 301 of the liquid ejection head 1 at the timing of input of a subsequent block trigger signal 514. Here, the data corresponding to one session of the time-division drive is transmitted in the form of the data signal from the liquid ejection head control unit 510 to the printing element substrate 201 in response to one block trigger signal 514.

FIG. 8 shows the data signal including 40 bits of the ejection group selection signals (0 to 39) and 6 bits of the ejection time-division selection signals (G0 to G5). Among multiple ejection drive elements MD1 included in the liquid ejection head 1, an ejection drive element MD1 to be activated is determined by the ejection group selection signal and the ejection time-division selection signal transferred from the liquid ejection head control unit 510. The ejection drive element MD1 thus determined drives the ejection energy generating element 214 corresponding to a period for which the enable signal indicates an enabled level, and the ink is ejected accordingly.

Here, activation of a specific ejection drive element MD1 is equivalent to causing the specific ejection drive element MD1 to drive the ejection energy generating element 214 corresponding thereto. Likewise, activation of a specific circulation drive element MD2 is equivalent to causing the specific circulation drive element MD2 to drive the circulation energy generating element 224 corresponding thereto.

FIG. 8 shows an example of forming the ejection time-division selection signals from 6 bits (G0 to G5). Accordingly, this configuration can deal with a structure in which 64 ejection energy generating elements 214 are included in one block at the maximum. However, since only 16 ejection energy generating elements 214 are included in one block in the present embodiment, the ejection time-division selection signals only need to be formed from 4 bits (G0 to G3). Therefore, 2 bits (G4 and G5) are redundant. Hence, the circulation cycle control signal is allocated to the bit G4 or G5 and is transferred to the printing element substrate 201. The circulation cycle control signal is allocated to the bit G4 as shown in FIG. 8, for example. In this way, it is possible to control the cycle to drive the circulation energy generating elements 224 as will be described later. In order to allocate the circulation cycle control signal to the bit G4, a circuit (not shown) for inserting the circulation cycle control signal outputted from the circulation cycle control signal generating unit 705 is provided to a slot for the bit G4 in the data signal outputted from the data signal generating unit 703 shown in FIG. 7, for example.

In the liquid ejection head 1, the circulation drive element MD2 supposed to drive the circulation energy generating element 224 is determined based on the circulation cycle control signal in addition to the ejection group selection signal and the ejection time-division selection signal received from the liquid ejection head control unit 510. Then, the circulation drive element MD2 determined as described above drives the circulation energy generating element 224 during a period in which the enable signal indicates an "enabled" state.

To be more precise, the circulation drive element MD2 supposed to be activated is narrowed down to the circulation drive element MD2 selected by the ejection time-division selection signal (first narrowing down). As a consequence of the first narrowing down, the circulation drive element MD2 supposed to be activated is narrowed down to one element for each group.

Here, the ejection time-division selection signal is subjected to masking by the circulation cycle control signal in accordance with the present disclosure. That is to say, even in the case where the ejection time-division selection signal indicates selection, it is equivalent to a situation where the ejection time-division selection signal indicates nonselection as long as the circulation cycle control signal indicates nonselection. Accordingly, in the case where the circulation cycle control signal indicates nonselection, there is no circulation drive element MD2 supposed to be activated.

In the meantime, the circulation drive element MD2 supposed to be activated is narrowed down to the circulation drive element MD2 that belongs to a group in which the ejection group selection signal indicates nonselection (second narrowing down). Here, a combination of the group in which the ejection group selection signal indicates selection and the group in which the ejection group selection signal indicates nonselection is freely determined. For example, in the case where the number of groups is equal to 10, the number of combinations is equal to 2¹⁰.

In this way, the circulation drive element MD2 narrowed down by multiplying the first narrowing down and the second narrowing down is selected as the circulation drive element MD2 supposed to be activated. Here, as mentioned above, there is no circulation drive element MD2 supposed to be activated in the case where the circulation cycle control signal indicates nonselection.

The ejection time-division selection signal is changed in such a way as to cyclically select the circulation drive element MD2 supposed to be activated within the group for each latch signal. In the case where the number of circulation drive elements MD2 is equal to N, the selection takes a round in every N pieces of the latch signals. Here, it is possible to change the cycle for the first narrowing down from N to 2N by adjusting the cycle of the circulation cycle control signals in such a way as to alternately repeat selection level/nonselection level in every N pieces of the latches, for example. Alternatively, it is possible to change the cycle for the first narrowing down from N to 3N by adjusting the cycle of the circulation cycle control signals in such a way as to take the selection level in a period of N pieces of the latches and to take the nonselection level in a period of 2N pieces of the latches, for example.

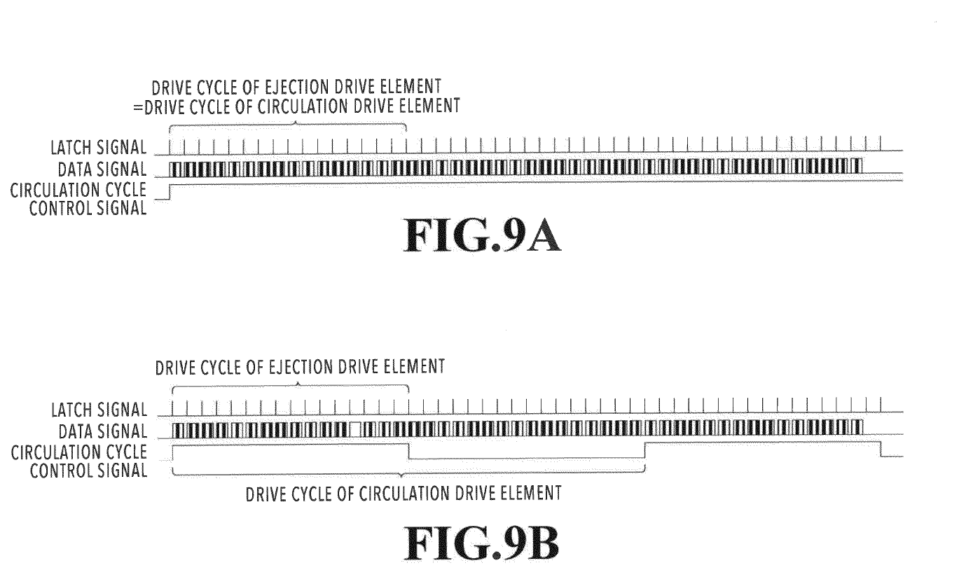

FIGS. 9A and 9B are timing charts showing examples of transfer timing of the ejection group selection signals and the circulation cycle control signals. In FIGS. 9A and 9B, the circulation cycle control signal is described as a different signal from the data signal. However, a configuration to contain the circulation cycle control signal as a portion of the data signal may be adopted, or a configuration to transmit the circulation cycle control signal from the liquid ejection head control unit 510 to the printing element substrate 201 as a different signal from the data signal may be adopted.

In case where activation cycle of ejection drive element is equal to activation cycle of circulation drive element.

FIG. 9A shows an example of not controlling the circulation cycle control signal. In the 16 time-division drive, 16 circulation energy generating elements 224 belong to one group. Then, one circulation energy generating element 224 is driven by one latch signal session. Accordingly, one cycle is fulfilled in the case where the latch signals are active 16 times. In the case of not controlling the circulation cycle control signal (that is to say, in the case of constantly setting the circulation cycle control signal to a level to instruct the drive), the circulation cycle control signal is continuously set to a selection level (a high level). Therefore, in the case of not controlling the circulation cycle control signal, an activation cycle of the ejection drive element MD1 is equal to an activation cycle of the circulation drive element MD2. For example, in the case where the activation cycle of the ejection drive element MD1 in the course of printing is equal to an optimum activation cycle for circulation, the circulation cycle control signal may be constantly maintained at the level to instruct the activation as shown in FIG. 9A.

On the other hand, an example shown in FIG. 9B is an example in the case of controlling the circulation cycle control signal. In FIG. 9B, the circulation cycle control signal is toggled between the selection level (the high level) and the nonselection level (the low level) every 16 times of the latch signals. Accordingly, the circulation drive element MD2 is activated in the activation cycle that is twice as long as the activation cycle of the ejection drive element MD1. For example, there is a case where an activation frequency of the ejection drive element MD1 in the course of printing is set equal to 20 kHz whereas the optimum activation frequency of the circulation drive element MD2 for circulation is equal to 10 kHz. In this case, the circulation cycle control signal is toggled every 16 times the latch signals become active as shown in FIG. 9B. Thus, it is possible to activate the circulation drive element MD2 in the activation cycle, which is twice as long as the activation cycle of the ejection drive element MD1 and is the optimum cycle for circulation. The circulation cycle control signal may be adjusted as described below in order to set the activation cycle of the circulation drive element MD2 N times as long as the activation cycle of the ejection drive element MD1. Specifically, the circulation cycle control signal may be designed to repeat a selection level period having the same length as the cycle of the ejection time-division selection signal and a nonselection level period having a length of a multiple (N-1) as long as the cycle of the ejection time-division selection signal.

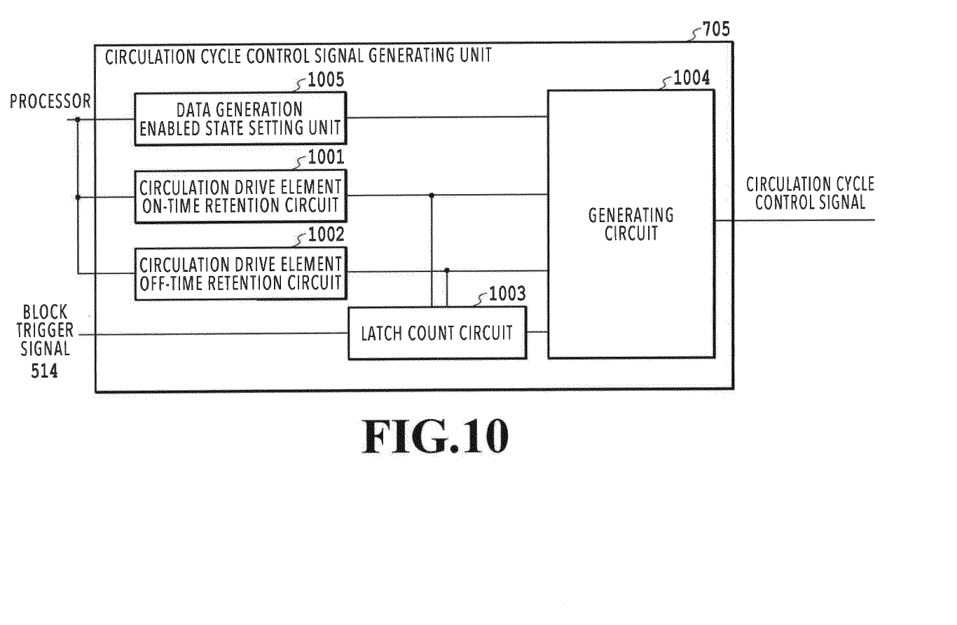

FIG. 10 is a functional block diagram showing a configuration example of the circulation cycle control signal generating unit 705. A circulation drive element on-time retention circuit 1001 is a circuit that can set as to how many times of the latch signals are to be used for continuously turning on the circulation cycle control signal, and this number of times can be set by the processor 507. A circulation drive element off time retention circuit 1002 is a circuit that can set as to how many times of the latch signals are to be used for continuously turning off the circulation cycle control signal, and this number of times can be set by the processor 507.

A latch count circuit 1003 is a circuit that counts the block trigger signals 514 being signals for generating the latch signals. The latch count circuit 1003 counts up the block trigger signals 514, and returns to zero after counting the number of block trigger signals set to the circulation drive element on-time retention circuit 1001. Subsequently, the latch count circuit 1003 counts up the block trigger signals 514, and returns to zero after counting the number of block trigger signals set to the circulation drive element off-time retention circuit 1002. The latch count circuit 1003 repeatedly performs these operations.

A generating circuit 1004 generates the circulation cycle control signals based on counted values counted with the latch count circuit 1003, the value set to the circulation drive element on-time retention circuit 1001, and the value set to the circulation drive element off-time retention circuit 1002. In this instance, generation of the circulation cycle control signals is not carried out in the case where a disabled state is set to a data generation enabled state setting unit 1005.

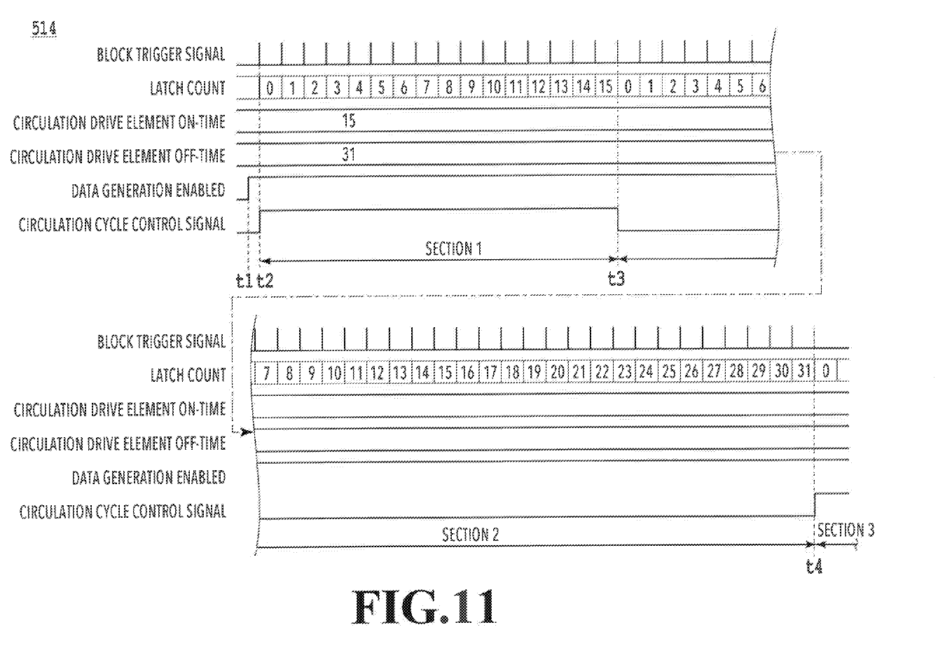

Actions of the circulation cycle control signal generating unit 705 will be discussed with reference to a timing chart of FIG. 11. At time t1, the data generation enabled state is set to the data generation enabled state setting unit 1005. From timing at time t2 of setting the data generation enabled state, the latch count circuit 1003 starts counting the block trigger signals 514. The latch count circuit 1003 resets the value of the counted latches to 0 in the case where the counted value reaches the value set to the circulation drive element on-time retention circuit 1001 (time t3). The latch count circuit 1003 starts counting up again, and resets the value of the counted latches to 0 in the case where the counted value reaches the value set to the circulation drive element off-time retention circuit 1002 (time t4). The aforementioned operations are repeated thereafter. In this instance, the generating circuit 1004 sets the circulation cycle control signal to the high level (that is to say, the level corresponding to an operable state) during a section 1 (from the time t2 to the time t3). Meanwhile, the generating circuit 1004 sets the circulation cycle control signal to the low level (that is to say, the level corresponding to an inoperable state) during a section 2 (from the time t3 to the time t4), and sets the circulation cycle control signal to the high level in a section 3.

The circulation cycle control signal generating unit 705 generates the circulation cycle control signal, and controls the activation of the circulation drive element MD2 on the printing element substrate 201 based on the ejection group selection signal, the ejection time-division selection signal, and the circulation cycle control signal as described above. In this way, it is possible to activate the circulation drive element MD2 in the different cycle from that of the ejection drive element MD1.

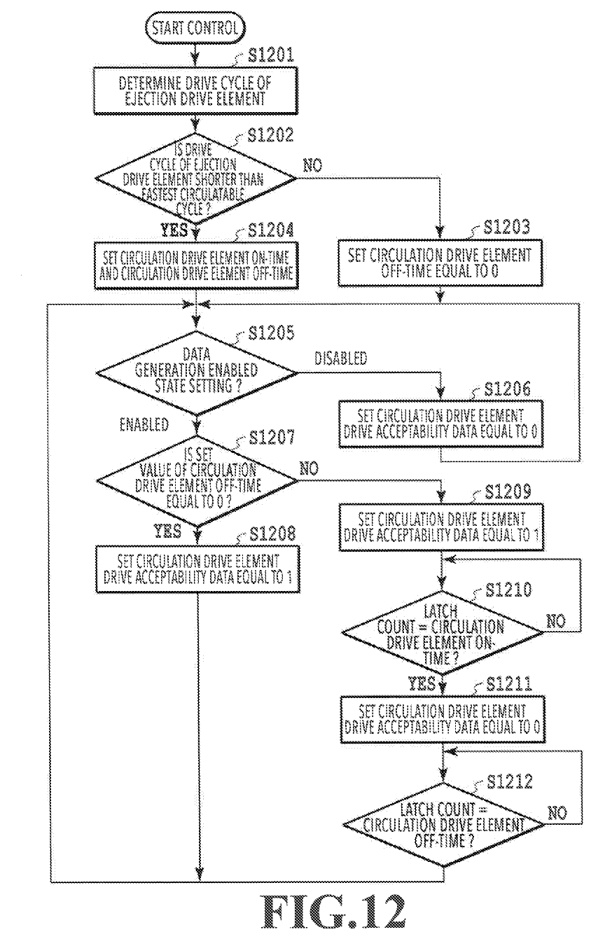

A control flow for generating the circulation cycle control signal will be described with reference to FIG. 12. In step S1201, the activation cycle of the ejection drive element MD1 in printing is determined.

In step S1202, the fastest activation cycle circulatable by the circulation drive element MD2 is compared with the activation cycle of the ejection drive element MD1 determined in step S1201. As a consequence of the comparison, step S1203 is carried out in a case where the activation cycle of the ejection drive element MD1 is longer than the fastest circulatable activation cycle, or step S1204 is carried out in a case where the activation cycle of the ejection drive element MD1 is shorter than the fastest circulatable activation cycle.

In step S1203, circulation drive element off-time is set to zero to the circulation drive element off-time retention circuit 1002.

In step S1204, the circulation drive element on-time retention circuit 1001 and the circulation drive element off-time retention circuit 1002 are subjected to setting such that circulation drive element on-time and the circulation drive element off time establish operable cycles.

In step S1205, a determination is made as to whether the state set to the data generation enabled state setting unit 1005 is the enabled state or the disabled state. Here, the setting to the data generation enabled state setting unit 1005 is assumed to be executable at any time.

In the case where the disabled state is set in step S1205, the generating circuit 1004 sets the circulation cycle control signal equal to zero in step S1206.

In the case where the enabled state is set in step S1205, the value set to the circulation drive element off-time retention circuit 1002 is checked in step S1207.

In the case where the set value of the circulation drive element off-time is equal to zero in step S1207, the generating circuit 1004 sets the circulation cycle control signal equal to 1 in step S1208. Step S1209 is carried out in the case where the set value of the circulation drive element off-time is not equal to zero in step S1207.

In steps S1209, S1210, S1211, and S1212, circulation drive element drive acceptability data is set equal to 1, and then the process waits for a lapse of the circulation drive on-time. Thereafter, the circulation drive element drive acceptability data is set equal to zero, and then the process waits for a lapse of the circulation drive offtime. Then, the process returns to S1205. By repeating the processes from steps S1209 to S1212 through steps S1205 and S1207, the circulation cycle control signals in which the value 1 is continued for the circulation drive on-time and the value zero is continued for the circulation drive off-time are repeated.

The circulating operation by the above-described control can be carried out in any conditions of the ink jet printing apparatus such as a state in the middle of carrying out printing while scanning with the liquid ejection head, and a state of stopping the liquid ejection head.

FIG. 13 shows a circuit configuration of the printing element substrate 201 of the embodiment together with the liquid ejection head control unit 510 and a power circuit 1301 which are mounted on a main body 50M of the liquid ejection apparatus 50. The printing element substrate 201 includes multiple ejection modules 1311 and multiple circulation modules 1312.

Each ejection module 1311 includes an ejection heater (an electrothermal transducing element) RhA that functions as the ejection energy generating element 214. In the meantime, the ejection module 1311 includes the ejection drive element (a transistor) MD1 for feeding an electric current to the heater RhA, and an ejection logic circuit AND1 for selectively activating the ejection drive element MD1. Heat is generated by feeding the electric current to the ejection heater RhA, and the ink is formed into a bubble and ejected so as to print on a print sheet surface.

Each circulation module 1312 includes a circulation heater (an electrothermal transducing element) RhB that functions as the circulation energy generating element 224. In the meantime, each circulation module 1312 includes the circulation drive element (a transistor) MD2 for feeding an electric current to the heater RhB, and a circulation logic circuit AND2 for selectively activating the circulation drive element MD2. Heat is generated by feeding the electric current to the circulation heater RhB so as to grow the ink bubble and to generate a circulating current in an ink supply flow channel.

Here, a piezoelectric element can be used as the ejection energy generating element 214 for ejecting the ink instead of the ejection heater RhA. Likewise, a piezoelectric element can be used as the circulation energy generating element 224 for circulating the ink instead of the circulation heater RhB.

An ejection group selection signal 1319, an ejection time-division selection signal 1318, and an enable signal HE are supplied to the ejection logic circuit AND1. The ejection group selection signal 1319 and the ejection time-division selection signal 1318 are outputted from a control data supply circuit 1331. The enable signal HE is designed for controlling a pulse width (time to feed the electric current by turning the ejection drive element MD1 on), which is supplied from the enable signal generating unit 704 of the liquid ejection head control unit 510 as mentioned earlier.

In the case where the ejection group selection signal 1319 indicates selection, the ejection time-division selection signal 1318 indicates selection, and the enable signal HE indicates the enabled state, the output from the ejection logic circuit AND1 is set to a high level. Accordingly, a conducted state of the ejection drive element MD1 is established and the electric current flows on the ejection heater RhA.

A circulation group selection signal (also referred to as a "circulation energy generation element selection signal") 1320, a circulation time-division selection signal 1333, and the enable signal HE are supplied to the circulation logic circuit AND2. The circulation group selection signal 1320 and the circulation time-division selection signal 1333 are outputted from the control data supply circuit 1331. The enable signal HE is for controlling a pulse width (time to feed the electric current by turning the circulation drive element MD2 on), which is supplied from the enable signal generating unit 704 of the liquid ejection head control unit 510 as mentioned earlier.

In the case where the circulation group selection signal 1320 indicates selection, the circulation time-division selection signal 1333 indicates selection, and the enable signal HE indicates the enabled state, the output from the circulation logic circuit AND2 is set to a high level. Accordingly, a conducted state of the circulation drive element MD2 is established and the electric current flows on the circulation heater RhB.

The control data supply circuit 1331 includes shift registers 1313a, 1313b, and 1313c, and latch circuits 1314a, 1314b, and 1314c as shown in FIG. 13, for example. The control data supply circuit 1331 includes external input terminals for a clock signal CLK, a data signal DATA, and a latch signal LT. The clock signal CLK is designed to transfer serial data of selection information on the ejection module 1311 and the circulation module 1312 to the shift registers 1313a, 1313b, and 1313c. The latch signal LT is designed to cause the latch circuits 1314a, 1314b, and 1314c to retain the selection information. The clock signal CLK, the data signal DATA, and the latch signal LT are supplied from the clock signal generating unit 701, the data signal generating unit 703, and the latch signal generating unit 702 of the liquid ejection head control unit 510, respectively.

The enable signal HE is a signal for adjusting an electric current pulse width so as to generate more desirable thermal energy in consideration of production tolerance of heater resistance values in the printing element substrate 201, production tolerance of a power supply and the like, and a voltage drop on power supply wiring in a case of driving multiple heaters at the same time. It is preferable to provide the enable signals HE individually for the purpose of ejection and circulation so as to control respective pulse widths accordingly. In the present embodiment, the single enable signal HE is shared for the purpose of ejection and circulation in order to reduce the number of signal terminals. Accordingly, it is not possible to control the pulse widths individually for the purpose of ejection and circulation. For this reason, the ejection heater RhA and the circulation heater RhB are formed in the same steps of a semiconductor manufacturing process. Then, it is preferable to adjust the pulse widths with the single enable signal HE on the assumption that the two types of heaters have the same production tolerance (an amount of misalignment of a resistance value relative to an ideal value).

Now, a drive control method for an ejection heater line 1321 having m groups each being assumed to include n pieces of the ejection heaters RhA will be described. A controlling method of the ejection heaters RhA in an amount of (n = 16 pieces)×(m = 40 groups) will be described below on the assumption that heater lines are arranged at an arrangement density of 600 dpi within a length of 1 inch, for example.

One ejection heater RhA is included in one ejection module 1311. Sixteen modules are included in one group. The n= 16 pieces of ejection modules 1311 in each group are subjected to time-division drive by the ejection time-division selection signal 1318. The time-division drive is a method of performing control in such a way as to divide a certain period of time of an ejection cycle into n = 16 units and to sequentially select ejection modules 1311 one by one in respective unit time periods thus divided. Two or more ejection heaters RhA are not selected at the same time in each group, and the control is carried out in such a way as to definitely select all of the ejection modules 1311 defined in accordance with the time-division at least once within one ejection cycle. In this instance, the ejection time-division selection signal 1318 is set to the state of selecting only one of signal lines. Accordingly, it is possible to further reduce an amount of serial transfer data from the liquid ejection apparatus 50 by mounting an ejection decoder circuit 1315 as shown in FIG. 13. Regarding an inputted data bit number q encoded into a binary number, the ejection decoder circuit 1315 expands an output data bit number to a number equal to 2 to the qth power. To be more precise, in the case of inputting 4-bit data to the ejection decoder circuit 1315, the ejection decoder circuit 1315 converts the data into the output data of 2⁴ = 16 bits. In this instance, the output signal data is outputted as information in which only one bit among 16 bits is valid. Regarding the signal lines outputted from the ejection decoder circuit 1315, it is more preferable to use the number of all the signal lines as the ejection time-division selection signal 1318 unless there is a special usage, because this configuration optimizes use efficiency of the input data. Here, an increase in serial transfer data requires faster serial data transfer. In the liquid ejection apparatus 50 and the printing element substrate 201, the amount of data is preferably reduced as much as possible because such an increase in data leads to increases in cost and size of signal transmission, reception circuits, and transmission lines.

The ejection group selection signals 1319 in the amount of m bits for selectively driving the respective groups included in them groups are outputted from the control data supply circuit 1331. The group selection is the control that enables simultaneous selection, and information corresponding to m bits being equal to the number of groups is serially transferred from the data signal generating unit 703 included in the liquid ejection head control unit 510. As mentioned above, the ejection module 1311 is subjected to selection control such that the electric current is fed to the ejection heater RhA at the corresponding location by inputting the ejection group selection signal 1319, the ejection time-division selection signal 1318, and the enable signal HE to the ejection logic circuit AND1. Although the present embodiment explains the example in which the value n is set equal to 16 and the value m is set equal to 40, the same control is assumed to be available by setting different values such as the value n equal to 8 and the value m equal to 80 or at different nozzle lengths of the value n equal to 32 and the value m equal to 40, and so forth. However, the number of time-division n is preferably a value expressed by a power of 2 (n = 2, 4, 8, 16, 32, and so on) because of the configuration to use the output signal from the decoder circuit as the selection signal.

Next, a drive control method for a circulation heater line 1322 will be described. The circulation heater RhB functions as the circulation energy generating element 224 that generates the ink circulation flow 227 in the individual flow channel 223 located adjacent to the ejection port 211 (see FIG. 2). The circulation heater RhB forms a pair with the ejection heater RhA disposed immediately below the ejection port 211, and is disposed close to the ejection heater RhA. The present embodiment will describe the method of subjecting the circulation heater line 1322 having the circulation heaters RhB in an amount of (n = 16 pieces)×(m = 40 groups), which are as many as the ejection heaters RhA, to selection control from the main body 50M of the liquid ejection apparatus 50.

One circulation heater RhB is included in one circulation module 1312. Sixteen modules are included in one group.

A frequency at which the latch signal LT is activated will be defined as a unit frequency and a cycle corresponding to the unit frequency will be defined as a unit cycle (here, the unit cycle is equal to a unit period of selection/nonselection of each ejection time-division selection signal 1318; that is to say, each ejection time-division selection signal 1318 can be selected or not selected in each unit period). The n pieces of the ejection drive elements MD1 included in each group are sequentially driven at such a cycle that takes a round in n×unit cycles (a full-circle cycle). On the other hand, the n pieces of circulation drive elements MD2 included in each group are sequentially driven at such a cycle that takes a round in p×unit cycles. Here, in the configuration shown in FIG. 13, p = 2, 2×n, 3×n, 4×n, and so on hold true, for example. That is to say, assuming that a value a is an integer, p = a×n holds true. In the case where the value n is equal to 16, the value p will be 16, 32, 48, 64, and so forth. The circulation cycle control signal is active inn periods and the circulation cycle control signal is inactive in (a-1)×n periods. For this reason, the circulation cycle control signal generating unit 705 generates the circulation cycle control signals based on the full-circle cycle of the ejection time-division selection signals 1318 as one unit, which include active periods equivalent to one unit without any inactive periods or with one or more units of the inactive periods.

Here, the value p is an integral multiple of the value n as described above. However, the value p does not always have to be an integral multiple of the value n. As will be described later, in a configuration shown in FIG. 15, the value p can be set to satisfy p = n+1, n+2, n+3, and so on. That is to say, assuming that a value b is an integer equal to or above 0, p = n+b holds true. In this case, the circulation cycle control signal is active inn periods and the circulation cycle control signal is inactive in b periods. In this instance, the drive cycle of the circulation energy generating element 224 can be set to (p/n) times as long as the drive cycle of the ejection energy generating element 214.

A portion related to the circulation drive element MD2 in the configuration shown in FIG. 13 will be described.

The control data supply circuit 1331 shown in FIG. 13 includes a circulation group selection signal generating unit 1316 and a circulation time-division selection signal generating unit 1341. The circulation time-division selection signal generating unit 1341 constitutes a second generating unit in the printing element substrate 201 shown in FIG. 13.

The circulation group selection signal generating unit 1316 is designed to generate the respective circulation group selection signals 1320 based on the respective ejection group selection signals 1319.

The circulation time-division selection signal generating unit 1341 is designed to generate the respective circulation time-division selection signals 1333 based on the respective ejection time-division selection signals 1318 and a circulation cycle control signal 1342.

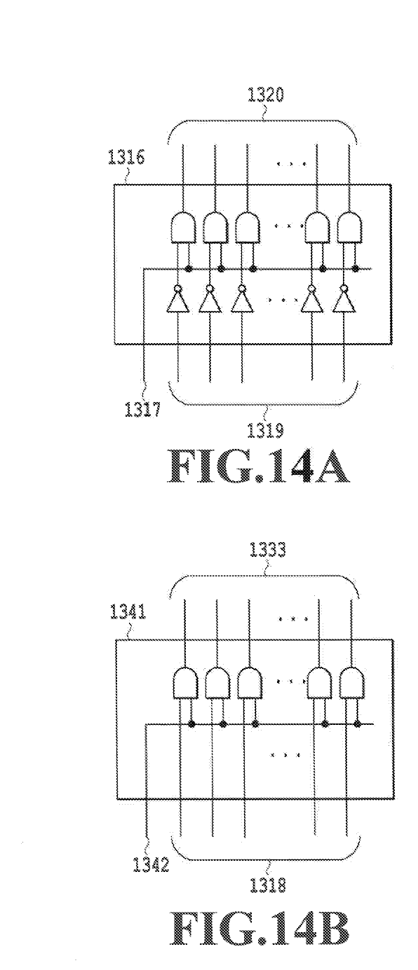

FIG. 14A shows a circuit diagram illustrating a configuration example of the circulation group selection signal generating unit 1316. As shown in FIG. 14A, the circulation group selection signal generating unit 1316 includes logical inversion gates for logically inverting respective ejection group selection signals 1319, and logical product gates each provided for obtaining a logical product of each logically inverted ejection group selection signal 1319 and a circulation flag signal 1317. Output from each logical product gate is used as each circulation group selection signal 1320.

The number of each set of these gates is equal to the number of groups. In the case where the number of groups is equal to 40, for example, the number of each set of these gates is equal to 40.

By setting the circulation flag signal 1317 to indicate invalidity, it is possible to inhibit selection of the circulation module 1312 at the time of an ordinary printing operation that does not require circulation of the inks.

In the case where the circulation flag signal 1317 indicates validity, each circulation group selection signal 1320 is equal to a value obtained by logically inverting each ejection group selection signal 1319.

FIG. 14B shows a circuit diagram illustrating a configuration of the circulation time-division selection signal generating unit 1341. As shown in FIG. 14B, the circulation time-division selection signal generating unit 1341 includes logical product gates each provided for obtaining a logical product of each ejection time-division selection signal 1318 and the circulation cycle control signal 1342. Output from each logical product gate is used as each circulation time-division selection signal 1333.

As shown in FIG. 11, for example, a logical level of the circulation cycle control signal 1342 is set to a high level during a period from latch counts Oto 15, and the logical level is set to a low level during a subsequent period from latch counts 0 to 31. In this case, 16 circulation time-division selection signals 1333 are sequentially set to the high level in initial 16 unit cycles. Then, all of the 16 circulation time-division selection signal 1333 are set to the low level in 32 unit cycles subsequent thereto. Accordingly, the cycle of each circulation time-division selection signal 1333 is equal to 48. This is three times as long as the cycle of each ejection time-division selection signal 1318. In this way, it is possible to set the cycle of each circulation time-division selection signal 1333 three times as long as the cycle of each ejection time-division selection signal 1318.

In a period of not carrying out the printing operation, for example, the logical level of every ejection group selection signal 1319 is set low and the high logical level of the circulation flag signal 1317 is maintained. In this way, it is possible to drive all the circulation heaters RhB that belong to the respective groups cyclically during this period. In this case, it is possible to control this cycle of taking a round by adjusting a cycle of the circulation cycle control signal 1342.

In the configuration shown in FIG. 13, the cycle to drive the respective circulation heaters RhB does not vary in the case of setting each of high periods and low periods of the logical level of the circulation cycle control signal 1342 equal to an integral multiple of the cycle of the ejection time-division selection signal 1318. In the operation example of FIG. 11, ajth circulation heater RhB in each group is driven at an (i×48+j)-th cycle in light of the unit cycle. However, the cycle to drive the respective circulation heaters RhB will vary unless each of the high periods and the low periods of the logical level of the circulation cycle control signal 1342 is set equal to an integral multiple of the cycle of the ejection time-division selection signal 1318. For example, the following situations will take place if the cycle of the ejection time-division selection signal 1318 is equal to 24, the high periods of the logical level in each cycle is equal to 16, and the low periods of the logical level in each cycle is equal to 8. For instance, the 0th circulation heater RhB will be driven at the 0th cycle, the 32nd cycle, the 48th cycle, and so on. In this case, intervals of the drive will be set to 32 cycles, 16 cycles, 32 cycles, 16 cycles, and so on. Likewise, intervals to drive each of the first to 15th circulation heaters RhB will also be set to 32 cycles, 16 cycles, 32 cycles, 16 cycles, and so on.

On the other hand, a configuration shown in FIG. 15 can equalize the intervals to drive each of the circulation heaters RhB in this case. Specifically, in the above-mentioned case, the intervals to drive each of the circulation heaters RhB can always be set equal to 24 cycles. Here, the high periods of the logical level of the circulation cycle control signal 1342 are set equal to 12 and the low periods thereof are set equal to 12 in each cycle in order to achieve these intervals.

A portion related to the circulation drive element MD2 in the configuration shown in FIG. 15 will be described.

The control data supply circuit 1331 shown in FIG. 15 includes the circulation group selection signal generating unit 1316, a circulation counter 1501, a circulation decoder 1502, and a circulation adjusting unit 1503. The circulation counter 1501, the circulation decoder 1502, and the circulation adjusting unit 1503 collectively constitute the second generating unit in the printing element substrate 201 shown in FIG. 15.

The circulation group selection signal generating unit 1316 is the same as the one shown in FIG. 13, which is designed to generate the respective circulation group selection signals 1320 based on the respective ejection group selection signals 1319.

The circulation counter 1501 is a counter configured to input the circulation cycle control signal 1342 as the enable signal and to input the latch signal LT as the clock signal. The circulation counter 1501 counts up at the same frequency as the unit frequency of selection/nonselection of the ejection time-division selection signal during the active period of the circulation cycle control signal 1342, and suspends count up during the inactive period of the circulation cycle control signal 1342. In this example, the circulation counter 1501 counts up cyclically from 0 to 15 by the latch signal LT at the time of the high logical level of the circulation cycle control signal 1342.

The circulation decoder 1502 decodes 4-bit output indicating any of numerical values from 0 to 15 of the circulation counter 1501, and expands this output into a 16-bit signal 1504. Accordingly, a level of the 16-bit output signal 1504 from the circulation decoder 1502 is cyclically set to a high level. Meanwhile, since the logical level of the circulation cycle control signal 1342 is low, the output signal 1504 at the high logical level does not change during the suspension of the circulation counter 1501.

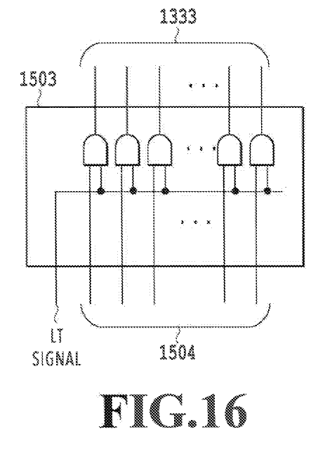

As shown in FIG. 16, the circulation adjusting unit 1503 calculates the logical product of the LT signal and each of the 16 output signals 1504 from the circulation decoder 1502, and outputs a result of calculation as each of the circulation time-division selection signals 1333. Accordingly, in the case where the logical level of the circulation cycle control signal 1342 is low, the logical levels of all of the circulation time-division selection signals 1333 are low.

As shown in FIG. 11, for example, the logical level of the circulation cycle control signal 1342 is set to the high level during the period from the latch counts 0 to 15, and the logical level is set to the low level during the subsequent period from the latch counts 0 to 31. In this case, 16 circulation time-division selection signals 1333 are sequentially set to the high level in initial 16 unit cycles. Then, all of the 16 circulation time-division selection signal 1333 are set to the low level in the 32 unit cycles subsequent thereto. Accordingly, the cycle of each circulation time-division selection signal 1333 is equal to 48. This is three times as long as the cycle of each ejection time-division selection signal 1318. In this way, it is possible to set the cycle of each circulation timedivision selection signal 1333 three times as long as the cycle of each ejection timedivision selection signal 1318.

In a period of not carrying out the printing operation, for example, the logical level of every ejection group selection signal 1319 is set low and the high logical level of the circulation flag signal 1317 is maintained. In this way, it is possible to drive all the circulation heaters RhB that belong to the respective groups cyclically during this period. In this case, it is possible to control this cycle of taking a round by adjusting the cycle of the circulation cycle control signal 1342.

In the configuration shown in FIG. 15, the intervals to drive each of the circulation heaters RhB can be equalized as described above even in the case where the cycle of the circulation cycle control signal 1342 is not an integral multiple of the cycle of the ejection time-division selection signal 1318. In other words, in the abovedescribed example, the intervals to drive each of the circulation heaters RhB can always be set equal to 24 cycles.

### Other embodiments

The above-described embodiment has explained the example of the ink jet printing apparatus that ejects the ink from the liquid ejection head. However, the ink jet printing apparatus can also be used as a liquid ejection apparatus that ejects a liquid other than the ink from a liquid ejection head.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present disclosure, it is possible to drive a circulation energy generating element at a frequency different from that for an ejection energy generating element while using at least part of information for selecting the ejection energy generating element in order to select the circulation energy generating element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173863, filed October 2, 2024, which is hereby incorporated by reference herein in its entirety.

What is claimed is:

1. A liquid ejection apparatus including
a liquid ejection head configured to eject a liquid to a print medium, and
a liquid ejection head control unit configured to control the liquid ejection head, the liquid ejection head comprising:
a plurality of ejection ports configured to eject the liquid;
a plurality of pressure chambers communicating with the plurality of ejection ports;
a plurality of ejection energy generating elements configured to generate energy for ejecting the liquid being present in the plurality of pressure chambers from the plurality of ejection ports;
a plurality of circulation energy generating elements configured to generate energy for circulating the liquid being present in the plurality of pressure chambers inside the liquid ejection head; and
a unit configured to input a plurality of ejection energy generating element selection signals, a plurality of ejection time-division selection signals, and a circulation cycle control signal,
wherein the liquid ejection head circulates the liquid by driving the circulation energy generating element selected by the circulation energy generation element selection signal and the circulation time-division selection signal, and
wherein the liquid ejection head control unit includes a first generating unit configured to generate the circulation cycle control signal such that a cycle of the plurality of circulation time-division selection signals is equal to or longer than a cycle of the plurality of ejection time-division selection signals.

2. The liquid ejection apparatus according to claim 1, wherein the liquid ejection head further includes a second generating unit configured to generate each of the circulation time-division selection signals based on each of the ejection time-division
selection signals and the circulation cycle control signal.

3. The liquid ejection apparatus according to claim 2, wherein
the first generating unit generates any of
the circulation cycle control signal being continuously set to a selection
level, and
the circulation cycle control signal configured to repeat a period at a selection level having a length equal to a cycle of the ejection time-division selection signals and a period at a nonselection level having a length equal to a multiple number of the cycle of the ejection time-division selection signals, and
the second generating unit generates the circulation time-division selection signal being equal to the ejection time-division selection signal in a case where the circulation cycle control signal is set to the selection level, and generates the circulation time-division selection signal set to a nonselection level in a case where the circulation cycle control signal is set to the nonselection level.

4. The liquid ejection apparatus according to claim 1, wherein the liquid ejection head further includes a second generating unit configured to generate each of the circulation time-division selection signals based on the circulation cycle control signal.

5. The liquid ejection apparatus according to claim 4, wherein the first generating unit generates any of
the circulation cycle control signal being continuously set to a selection level, and
the circulation cycle control signal configured to repeat a period at a selection level equivalent to an integral multiple of a period in which each of the ejection time-division selection signals is set to a selection level and a period at a nonselection level equivalent to an integral multiple of the period in which each of the ejection timedivision selection signals is set to the selection level, and
the second generating unit includes
a circulation counter configured to count up every time the ejection time-division selection signal having the selection level is switched during a period in which the circulation cycle control signal is set to the selection level, and
a unit configured to generate a plurality of circulation time-division selection signals by obtaining logical products of a plurality of signals obtained by expanding a count value outputted from the circulation counter and the circulation cycle control signal.

6. The liquid ejection apparatus according to claim 1, wherein the liquid ejection head further includes a unit configured to generate each of the circulation energy generation element selection signals based on each of the ejection energy generating element selection signals.

7. The liquid ejection apparatus according to claim 1, wherein the liquid ejection head ejects the liquid by driving the ejection energy generating element selected by the ejection energy generating element selection signal and the ejection time-division selection signal.

8. The liquid ejection apparatus according to claim 7, wherein the ejection energy generating element selected by the ejection energy generating element selection signal and the ejection time-division selection signal ejects the liquid in accordance with an enable signal to designate a period to drive the ejection energy generating element.

9. The liquid ejection apparatus according to claim 1, wherein the circulation energy generating element selected by the circulation energy generation element selection signal and the circulation time-division selection signal ejects the liquid in accordance with an enable signal to designate a period to drive the circulation energy generating element.

10. The liquid ejection apparatus according to claim 1, wherein
each of the plurality of ejection energy generating element selection signals corresponds to each of the plurality of circulation energy generation element selection signals, and
each of the circulation energy generation element selection signal is set to a nonselection level in a case where the ejection energy generating element selection signal corresponding to the circulation energy generation element selection signal is set to a selection level.

11. The liquid ejection apparatus according to claim 10, wherein each of the circulation energy generation element selection signals is set to any of a selection level and a nonselection level in accordance with a circulation flag in a case where the ejection energy generating element selection signal corresponding to the circulation energy generation element selection signal is set to a nonselection level.

12. A liquid ejection head control device configured to control a liquid ejection head for ejecting a liquid to a print medium,
the liquid ejection head comprising:
a plurality of ejection ports configured to eject the liquid;
a plurality of pressure chambers communicating with the plurality of ejection ports;
a plurality of ejection energy generating elements configured to generate energy for ejecting the liquid being present in the plurality of pressure chambers from the plurality of ejection ports;
a plurality of circulation energy generating elements configured to generate energy for circulating the liquid being present in the plurality of pressure chambers inside the liquid ejection head; and
a unit configured to input a plurality of ejection energy generating element selection signals, a plurality of ejection time-division selection signals, and a circulation cycle control signal,
wherein the liquid is circulated by driving the circulation energy generating element selected by the circulation energy generation element selection signal and the circulation time-division selection signal, and
wherein the liquid ejection head control device includes a generating unit configured to generate the circulation cycle control signal such that a cycle of a plurality of circulation time-division selection signals is equal to or longer than a cycle of the plurality of ejection time-division selection signals.

13. A liquid ejection head configured to eject a liquid to a print medium, wherein
the liquid ejection head is controlled by a liquid ejection head control device,
the liquid ejection head comprising:
a plurality of ejection ports configured to eject the liquid;
a plurality of pressure chambers communicating with the plurality of ejection
ports;
a plurality of ejection energy generating elements configured to generate energy for ejecting the liquid being present in the plurality of pressure chambers from the plurality of ejection ports;
a plurality of circulation energy generating elements configured to generate energy for circulating the liquid being present in the plurality of pressure chambers inside the liquid ejection head; and
a unit configured to input a plurality of ejection energy generating element selection signals, a plurality of ejection time-division selection signals, and a circulation cycle control signal,
wherein the liquid ejection head circulates the liquid by driving the circulation energy generating element selected by the circulation energy generation element selection signal and the circulation time-division selection signal, and
wherein the liquid ejection head control device includes a generating unit configured to generate the circulation cycle control signal such that a cycle of a plurality of circulation time-division selection signals is equal to or longer than a cycle of the plurality of ejection time-division selection signals.

14. A liquid ejection head controlling method for controlling a liquid ejection head configured to eject a liquid to a print medium,
the liquid ejection head comprising:
a plurality of ejection ports configured to eject the liquid;
a plurality of pressure chambers communicating with the plurality of ejection ports;
a plurality of ejection energy generating elements configured to generate energy for ejecting the liquid being present in the plurality of pressure chambers from the plurality of ejection ports;
a plurality of circulation energy generating elements configured to generate energy for circulating the liquid being present in the plurality of pressure chambers inside the liquid ejection head; and
a unit configured to input a plurality of ejection energy generating element selection signals, a plurality of ejection time-division selection signals, and a circulation cycle control signal,
wherein the liquid is circulated by driving the circulation energy generating element selected by the circulation energy generation element selection signal and the circulation time-division selection signal, and
wherein the liquid ejection head controlling method includes the step of generating the circulation cycle control signal such that a cycle of a plurality of circulation time-division selection signals is equal to or longer than a cycle of the plurality of ejection time-division selection signals.
